(19) United States
(12) Patent Application Publication
(10) Pub. No.: US 2014/0079281 A1
(43) Pub. Date: Mar. 20, 2014

(54) AUGMENTED REALITY CREATION AND CONSUMPTION

(71) Applicant: GRAVITY JACK, INC., Liberty Lake, WA (US)

(72) Inventors: Mitchell Dean Williams, Liberty Lake, WA (US); Shawn David Poindexter, Coeur d'Alene, ID (US); Matthew Scott Wilding, Spokane, WA (US); Benjamin William Hamming, Spokane, WA (US); Marc Andrew Rollins, Spokane, WA (US); Randal Sewell Ridgway, Spokane, WA (US); Damon John Buck, Dubai (AE); Aaron Luke Richey, Liberty Lake, WA (US)

(73) Assignee: GRAVITY JACK, INC., Liberty Lake, WA (US)

(21) Appl. No.: 13/621,793

(22) Filed: Sep. 17, 2012

(51) Int. Cl. G06K 9/62

(52) U.S. Cl. CPC G06K 9/62
USPC 382/103

(57) ABSTRACT

Architectures and techniques for augmenting content on an electronic device are described herein. In particular implementations, a user may use a portable device (e.g., a smart phone, tablet computer, etc.) to capture images of an environment, such as a room, outdoors, and so on. As the images of the environment are captured, the portable device may send information to a remote device (e.g., server) to determine whether augmented reality content is associated with a textured target in the environment (e.g., a surface or portion of a surface). When such a textured target is identified, the augmented reality content may be sent to the portable device. The augmented reality content may be displayed in an overlaid manner on the portable device as real-time images are displayed.

### BACKGROUND

A growing number of people are using electronic devices, such as smart phones, tablets computers, laptop computers, portable media players, and so on. These individuals often use the electronic devices to consume content, purchase items, and interact with other individuals. In some instances, an electronic device is portable, allowing an individual to use the electronic device in different environments, such as a room, outdoors, a concert, etc. As more individuals use electronic devices, there is an increasing need to enable these individuals to interact with their electronic devices in relation to their environment.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates an example architecture in which content may be provided through an electronic device to augment an environment of the electronic device.

FIG. 2 illustrates further details of the example computing device of FIG. 1.

FIG. 3 illustrates additional details of the example augmented reality service of FIG. 1.

FIGS. 4A-4C illustrate example interfaces for scanning an environment in a QAR or QR search mode.

FIGS. 5A-5E illustrate example interfaces for scanning an environment in a visual search mode.

FIGS. 6A-6B illustrate example interfaces for scanning an environment in a social media search mode.

FIGS. 7A-7C illustrate example interfaces for generating a personalized QAR or QR code.

FIG. 8 illustrates an example process for searching within an environment for a textured target that is associated with augmented reality content and outputting the augmented reality content when such a textured target is recognized.

FIG. 9 illustrates an example process for analyzing feature information to identify a textured target and providing augmented reality content that is associated with the textured target.

FIG. 10 illustrates an example process for generating augmented reality content.

### DETAILED DESCRIPTION

This disclosure describes architectures and techniques directed to augmenting content on an electronic device. In particular implementations, a user may use a portable device (e.g., a smart phone, tablet computer, etc.) to capture images of an environment, such as a room, outdoors, and so on. As the images of the environment are captured, the portable device may send information to a remote device (e.g., server) to determine whether augmented reality content is associated with a textured target in the environment (e.g., a surface or portion of a surface). When such a textured target is identified, the augmented reality content may be sent to the portable device from the remote device or another remote device (e.g., a content source). The augmented reality content may be displayed in an overlaid manner on the portable device as real-time images of the environment are displayed. The augmented reality content may be maintained on a display of the portable device in relation to the textured target (e.g., displayed over the target) as the portable device moves throughout the environment. By doing so, the user may view the environment in a modified manner. One implementation of the techniques described herein may be understood in the context of the following illustrative and non-limiting example.

As Joe is walking down the street, he starts the camera on his phone to scan the street, building, and other objects within his view. The phone displays real-time images of the environment that are captured through the camera. As the images are captured, the phone analyzes the images to determine features that are associated with a textured target in the environment (e.g., a surface or portion of a surface). The features may comprise points of interest in an image. The features may be represented by feature information, such as feature descriptors (e.g., a patch of pixels).

As Joe passes a particular building, his phone captures an image of a poster board taped to the side of the building stating “Luke for President.” Feature information of the textured target, in this example the poster board, is sent to a server located remotely to Joe's cell phone. The server analyzes the feature information to identify the textured target as the “Luke for President” poster. After the server recognizes the poster, the server determines whether content is associated with the poster. In this example, a particular interface element has been previously associated with the poster board. The server sends the interface element to Joe's phone. As Joe's cell phone is still capturing and displaying images of the “Luke for President” poster board, the interface element is displayed on Joe's phone in an overlaid manner at a location where the poster board is being displayed. The interface element allows Joe to indicate which candidate he will vote for as president, Luke or Mitch. Joe selects Luke through the interface element, and the phone is updated with poll information indicating which of the candidates is in the lead. As Joe moves his phone with respect to the environment, the display is updated to maintain the polling information in relation to the “Luke for President” poster.

In some instances, by augmenting content through an electronic device, a user's experience with an environment may be enhanced. That is, by displaying content simultaneously with a real-time image of an environment, such as in the case of Joe viewing the interface element over the “Luke for President” poster, the user may view the environment with additional content. In some instances, this may allow individuals, such as artists, authors, advertisers, consumers, and so on, to associate content with relatively static surfaces.

This brief introduction is provided for the reader's convenience and is not intended to limit the scope of the claims, nor the proceeding sections. Furthermore, the techniques described in detail below may be implemented in a number of ways and in a number of contexts. One example implementation and context is provided with reference to the following figures, as described below in more detail. It is to be appreciated, however, that the following implementation and context is but one of many.

### Example Architecture

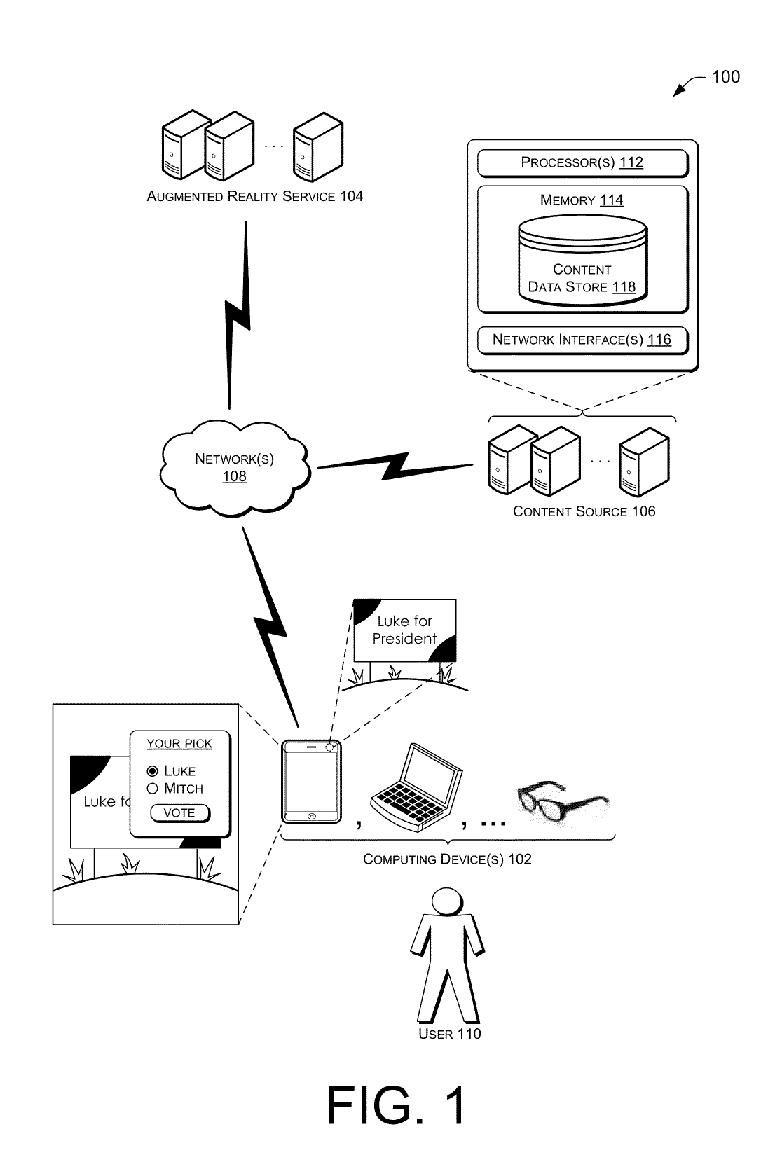

FIG. 1 illustrates an example architecture 100 in which techniques described herein may be implemented. In particular, the architecture 100 includes one or more computing devices 102 (hereinafter the device 102) configured to communicate with an Augmented Reality (AR) service 104 and a content source 106 over a network(s) 108. The device 102 may augment a reality of a user 110 associated with the device 102 by modifying the environment that is perceived by the user 110. In many examples described herein, the device 102 augments the reality of the user 102 by modifying a visual perception of the environment (e.g., adding visual content). However, the device 102 may additionally, or alternatively, modify other sense perceptions of the environment, such as a taste, sound, touch, and/or smell.

In general, the device 102 may perform two main types of analyses, geographical and optical, to determine when to modify the environment. In a geographical analysis, the device 102 primarily relies on a reading from an accelerometer, compass, gyroscope, magnetometer, Global Positioning System (GPS), or other similar sensor on the device 102. For example, here the device 102 may display augmented content when it is detected, through a sensor of the device 102, that the device 102 is within a predetermined proximity to a particular geographical location or that the device 102 is imaging a particular geographical location. Meanwhile, in an optical analysis, the device 102 primarily relies on optically captured information, such as a still or video image from a camera, information from a range camera, LIDAR detector information, and so on. For instance, here the device 102 may display augmented content when the device 102 detects a fiduciary marker, a particular textured target, a particular object, a particular light oscillation pattern, and so on. A fiduciary marker may comprise a textured target having a particular shape, such as a square or rectangle. In many instances, the content to be augmented is included within the fiduciary marker as an image having a particular pattern (Quick Augmented Reality (QAR) or QR code).

In some instances, the device 102 may rely on a combination of geographical information and optical information to create an AR experience. For example, the device 102 may capture an image of an environment and identify a textured target. The device 102 may also determine a geographical location being imaged or a geographical location of the device 102 to confirm the identity of the textured target and/or to select content. To illustrate, the device 102 may capture an image of the Statue of Liberty and process the image to identity the Statue. The device 102 may then confirm the identity of the Statue by referencing geographical location information of the device 102 or of the image.

The device 102 may be implemented as, for example, a laptop computer, a desktop computer, a smart phone, an electronic reader device, a mobile handset, a personal digital assistant (PDA), a portable navigation device, a portable gaming device, a tablet computer, a watch, a portable media player, a hearing aid, a pair of glasses or contacts having computing capabilities, a transparent or semi-transparent glass having computing capabilities (e.g., heads-up display system), another client device, and the like. In some instances, when the device 102 is at least partly implemented by a transparent or semi-transparent glass, such as a pair of glass, contacts, or a heads-up display, computing resources (e.g., processor, memory, etc.) may be located in close proximity to the glass, such as within a frame of the glasses. Further, in some instance when the device 102 is at least partly implemented by glass, images (e.g., video or still images) may be projected or otherwise provided on the glass for perception by the user 110.

The AR service 104 may generally communicate with the device 102 and/or the content source 106 to facilitate an AR experience on the device 102. For example, the AR service 104 may receive feature information from the device 102 and process the information to determine what the information represents. The AR service 104 may also identify AR content associated with textured targets of an environment and cause the AR content to be sent to the device 102.

The AR service 104 may be implemented as one or more computing devices, such as one or more servers, laptop computers, desktop computers, and the like. In one example, the AR service 104 includes computing devices configured in a cluster, data center, cloud computing environment, or a combination thereof.

The content source 106 may generally store and/or provide content to the device 102 and/or to the AR service 104. When the content is provided to the AR service 104, the content may be stored and/or resent to the device 102. At the device 102, the content is used to facilitate an AR experience. That is, the content may be displayed with a real-time image of an environment. In some instances, the content source 106 provides content to the device 102 based on a request from the AR service 104, while in other instances the content source 106 may provide the content without such a request.

In some examples, the content source 106 comprises a third party source associated with electronic commerce, such as an online retailer offering items for acquisition (e.g., purchase). As used herein, an item may comprise a tangible item, intangible item, product, good, service, bundle of items, digital good, digital item, digital service, coupon, and the like. In one instance, the content source 106 offers digital items for acquisitions, which include digital audio and video. Further, in some examples the content source 106 may be more directly associated with the AR service 104, such as a computing device acquired specifically for AR content and that is located proximately or remotely to the AR service 104. In yet further examples, the content source 106 may comprise a social networking service, such as an online service facilitating social relationships.

The content source 106 is equipped with one or more processors 112, memory 114, and one or more network interfaces 116. The memory 114 may be configured to store content in a content data store 118. The content may include any type of content including, for example:
Media content, such as videos, images, audio, and so on.
Item details of an item offered for acquisition. For example, the item details may include a price of an item, a quantity of the item, a discount associated with an item, a seller, artist, author, or distributor of an item, and so on. In some instances, the item details may be sent to the device 102 when a textured target that is associated with the item details is identified. For example, if a poster for a recently released movie is identified at the device 102, item details for the movie (indicating a price to purchase the movie) could be sent to the device 102 to be displayed as the movie poster is viewed.
Social media content or information. Social media content may include, for example, posted text, posted images, posted videos, profile information, and so on. While social media information may indicate that social media content is associated with a particular location. In some instances, when the device 102 is capturing an image of a particular geographical location, social media information may initially be sent to the device 102 indicating that that social media content is associated with the geographical location. Thereafter, the user 110 may request (e.g., through selection of an icon) that the social media content be sent to the device 102. Further, in some instances the social media information may include an icon to allow the user to “follow” another user.
Interactive content that is selectable by the user 110, such as menus, icons, and other interface elements. In one example, when a textured target, such as the “Luke for President” poster, is identified in the environment of the user 110, an interface menu for polling the user 110 is sent to the device 102.
Content that is uploaded to be specifically used for AR. For example, an author may upload supplemental content for a particular book that is available by the author. When the particular book is identified in an environment, the supplemental content may be sent to the device 102 to enhance the user's 110 experience with the book.
Any other type of content.

Although the content data store 118 is illustrated in the architecture 100 as being included in the content source 106, in some instances the content data store 118 is included in the AR service 104 and/or in the device 102. As such, in some instances the content source 106 may be eliminated entirely.

The memory 114 (and all other memory described herein) may include one or a combination of computer readable storage media. Computer storage media includes volatile and non-volatile, removable and non-removable media implemented in any method or technology for storage of information such as computer readable instructions, data structures, program modules, or other data. Computer storage media includes, but is not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device. As defined herein, computer storage media does not include communication media, such as modulated data signals and carrier waves. As such, computer storage media includes non-transitory media.

As noted above, the device 102, AR service 104, and/or content source 106 may communicate via the network(s) 108. The network(s) 108 may include any one or combination of multiple different types of networks, such as cellular networks, wireless networks, Local Area Networks (LANs), Wide Area Networks (WANs), and the Internet.

In returning to the example of Joe discussed above, the architecture 100 may be used to augment content onto a device associated with Joe. For example, Joe may be acting as the user 110 and operating his phone (the device 102) to capture an image of the “Luke for President” poster, as illustrated. Upon identifying the poster, Joe's phone may display a window in an overlaid manner over the poster. The window may allow Joe to indicate who he will be voting for as president. By doing so, Joe may view the environment in a modified manner.

### Example Computing Device

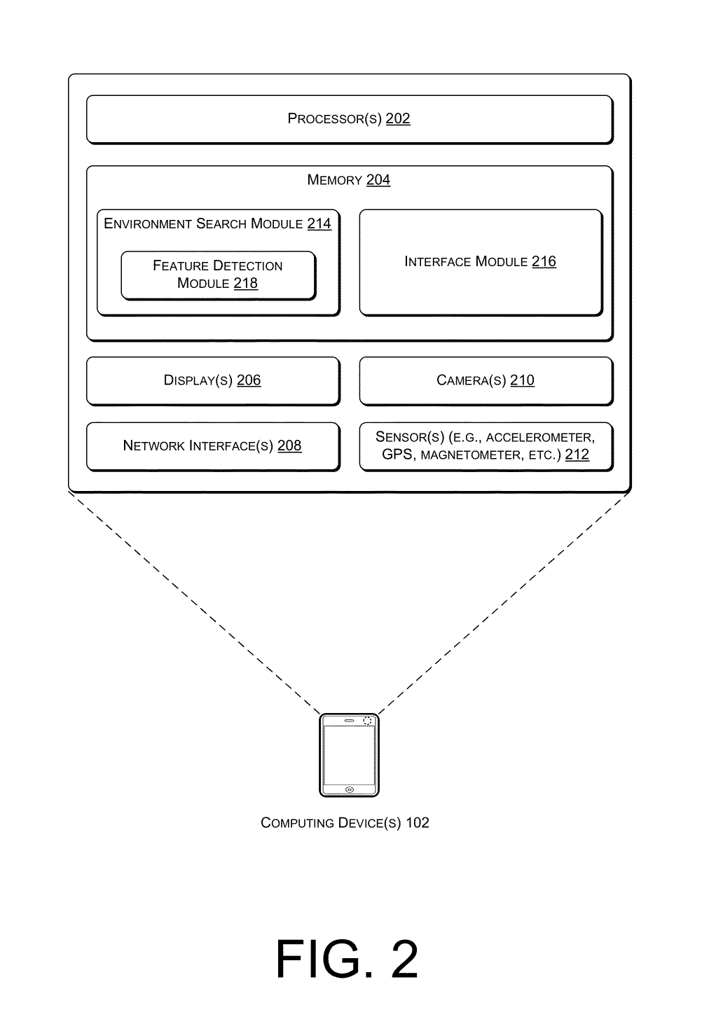

FIG. 2 illustrates further details of the example computing device 102 of FIG. 1. The device 102 is equipped with one or more processors 202, memory 204, one or more displays 206, one or more network interfaces 208, one or more cameras 210, and one or more sensors 212. In some instances, the one or more displays 206 include one or more touch screen displays. The one or more cameras 210 may include a front facing camera and a rear facing camera. The one or more sensors 212 may include an accelerometer, compass, gyroscope, magnetometer, Global Positioning System (GPS), olfactory sensor (e.g., for smell), microphone (e.g., for sound), tactile sensor (e.g., for touch), or other sensor.

The memory 204 may include software functionality configured as one or more “modules.” However, the modules are intended to represent example divisions of the software for purposes of discussion, and are not intended to represent any type of requirement or required method, manner or necessary organization. Accordingly, while various “modules” are discussed, their functionality and/or similar functionality could be arranged differently (e.g., combined into a fewer number of modules, broken into a larger number of modules, etc.).

In the example device 102, the memory 204 includes an environment search module 214 and an interface module 216. The environment search module 214 includes a feature detection module 218. The environment search module 214 may generally facilitate searching within an environment to identify a textured target. For example, the search module 214 may cause one or more images to be captured through a camera of the device 102. The search module 214 may then cause the feature detection module 218 to analyze the image in order to identify features in the image that are associated with a textured target. The search module 214 may then send the feature information representing the features to the AR service 104 for analysis (e.g., to identify the textured target and possibly identify content associated with the textured target). When information or content is received from the AR service 104 and/or the content source 106, the search module 214 may cause certain operations to be performed, such as the display of content through the interface module 216.

As noted above, the feature detection module 216 may analyze an image to determine features of the image. The features may correspond to points of interest in the image (e.g., corners) that are associated with a textured target. The textured target may comprise a surface or a portion of a surface within the environment that has a particular textured characteristic. To detect features in an image, the detection module 216 may utilize one or more feature detection and description algorithms commonly known to those of ordinary skill in the art, such as FAST, SIFT, SURF, or ORB. In some instances, once the features have been detected, the detection module 216 may extract or generate feature information, such as feature descriptors, describing the features. For example, the detection module 216 may extract a patch of pixels (block of pixels) centered on the feature. As noted above, the feature information may be sent to the AR service 104 for further analysis in order to identify a textured target (e.g., a surface or portion of a surface having particular textured characteristics).

The interface module 216 may generally facilitate interaction with the user 110 through one or more user interface elements. For example, the interface module 216 may display icons, menus, and other interface elements and receive input from a user through selection of an element. The interface module 216 may also display a real-time image of an environment and/or display content in an overlaid manner over the real-time image to create an AR experience for the user 110. As the device 102 moves relative to the environment, the interface module 216 may update a displayed location, orientation, and/or scale of the content so that the content maintains a relation to a target within the environment (e.g., so that the content is perceived as being within the environment).

In some instances, the memory 214 may include other modules. In one example, a tracking module is included to track a textured target through different images. For example, the tracking module may find potential features with the feature detection module 216 and match them up with a “template matching” technique.

### Example Augmented Reality Service

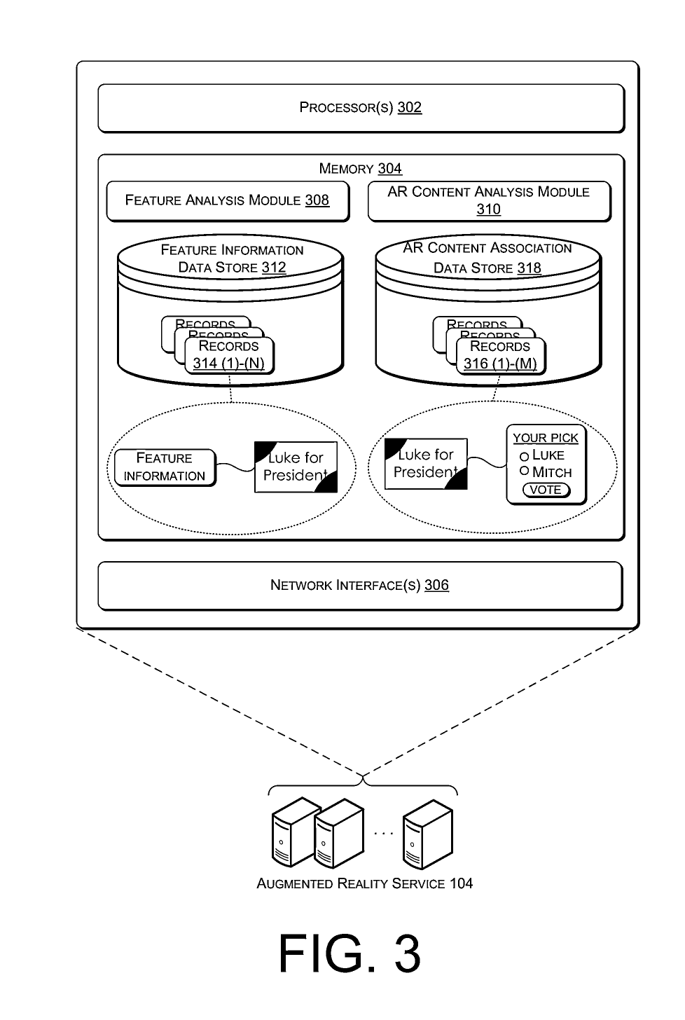

FIG. 3 illustrates additional details of the example AR service 104 of FIG. 1. The AR service 104 may include one or more computing devices that are each equipped with one or more processors 302, memory 304, and one or more network interfaces 306. As noted above, the computing devices of the AR service 104 may be configured in a cluster, data center, cloud computing environment, or a combination thereof In one example, the AR service 104 provides cloud computing resources, including computational resources, storage resources, and the like in a cloud environment.

As similarly discussed above with respect to the memory 204, the memory 304 may include software functionality configured as one or more “modules.” However, the modules are intended to represent example divisions of the software for purposes of discussion, and are not intended to represent any type of requirement or required method, manner or necessary organization. Accordingly, while various “modules” are discussed, their functionality and/or similar functionality could be arranged differently (e.g., combined into a fewer number of modules, broken into a larger number of modules, etc.).

In the example AR service 104, the memory 304 includes a feature analysis module 308 and an AR content analysis module. The feature analysis module 308 is configured to analyze feature information to identify a textured target. For example, the analysis module 308 may compare feature information received from the device 102 to a plurality of pieces of feature information stored in a feature information data store 312 (e.g., feature information library). The pieces of feature information of the data store 312 may be stored in records 314 1-N that each link a textured target (e.g., surface, portion of a surface, object, etc.) to feature information. As illustrated, the “Luke for President” poster (e.g., textured target) is associated with particular feature information. The feature information from the plurality of pieces of feature information that most closely matches the feature information being analyzed may be selected and the associated textured target may be identified.

The AR content analysis module 310 is configured to perform various operations for creating and providing AR content. For example, the module 310 may provide an interface to enable users, such as authors, publishers, artists, distributors, advertisers, and so on, to create an association between a textured target and content. Further, upon identifying a textured target within an environment of the user 110 (through analysis of feature information as described above), the analysis module 310 may determine whether content is associated with the textured target by referencing records 316 1-M stored in an AR content association data store 318. Each of the records 316 may provide a link between a textured target and content. To illustrate, Luke may register a campaign schedule with his “Luke for President” poster by uploading an image of his poster and his campaign schedule or a link to his campaign schedule. Thereafter, when the user 110 views the poster through the device 102, the AR service 104 may identify this association and provide the schedule to the device 102 to be consumed in as AR content.

The AR content analysis module 310 may also generate content to be output on the device 102 in an AR experience. For instance, the module 310 may aggregate information from a plurality of devices and generate content for AR based on the aggregated information. The information may comprise input from users of the plurality of devices indicating an opinion of the users, such as polling information.

Additionally, or alternatively, the module 310 may modify content based on a geographical location of the device 102, profile information of the user 110, or other information, before sending the content to the device 102. To illustrate, suppose the user 110 is at a concert of a particular band and captures an image of a CD that is being offered for sale. The AR service 104 may recognize the CD by analyzing the image and identify that an item detail page for a t-shirt of the band is associated the CD. In this example, the particular band has indicated that the t-shirt may be sold for a discounted price at the concert. Thus, before the item detail page is sent to the device 102, the list price on the item detail page may be updated to reflect the discount. To add to this illustration, suppose that profile information of the user 110 is made available to the AR service 104 through the express authorization of the user 110. If, for instance, a further discount is provided for a particular gender (e.g., due to decreased sales for the particular gender), the list price of the t-shirt may be updated to reflect this further discount.

### Example Interfaces

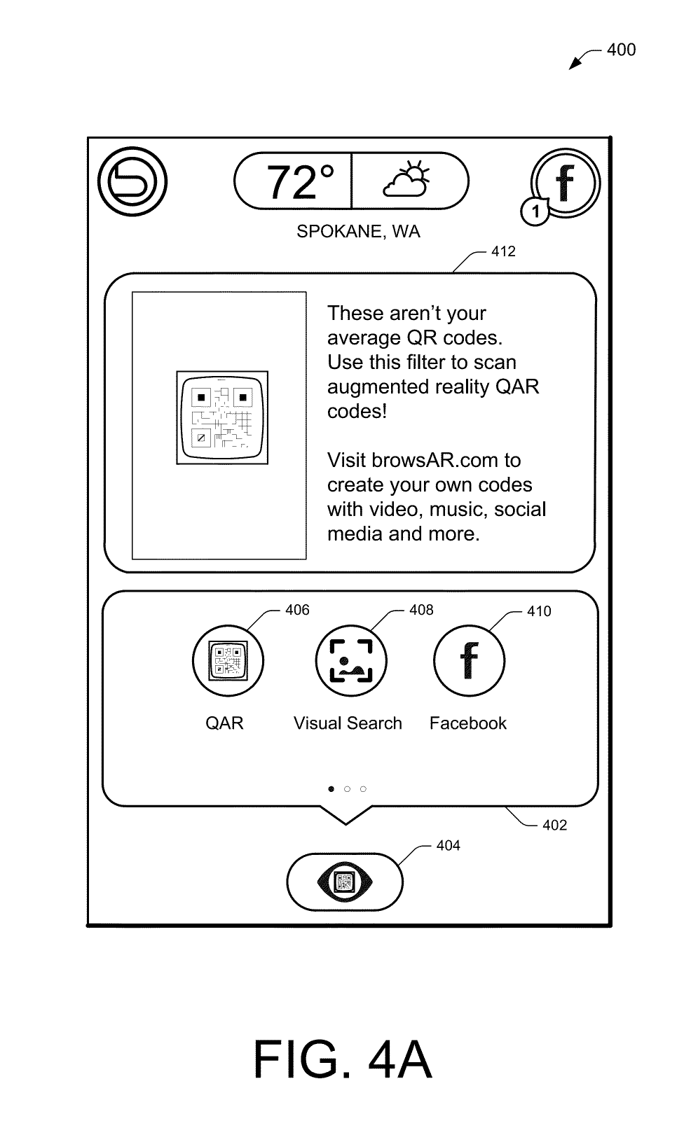

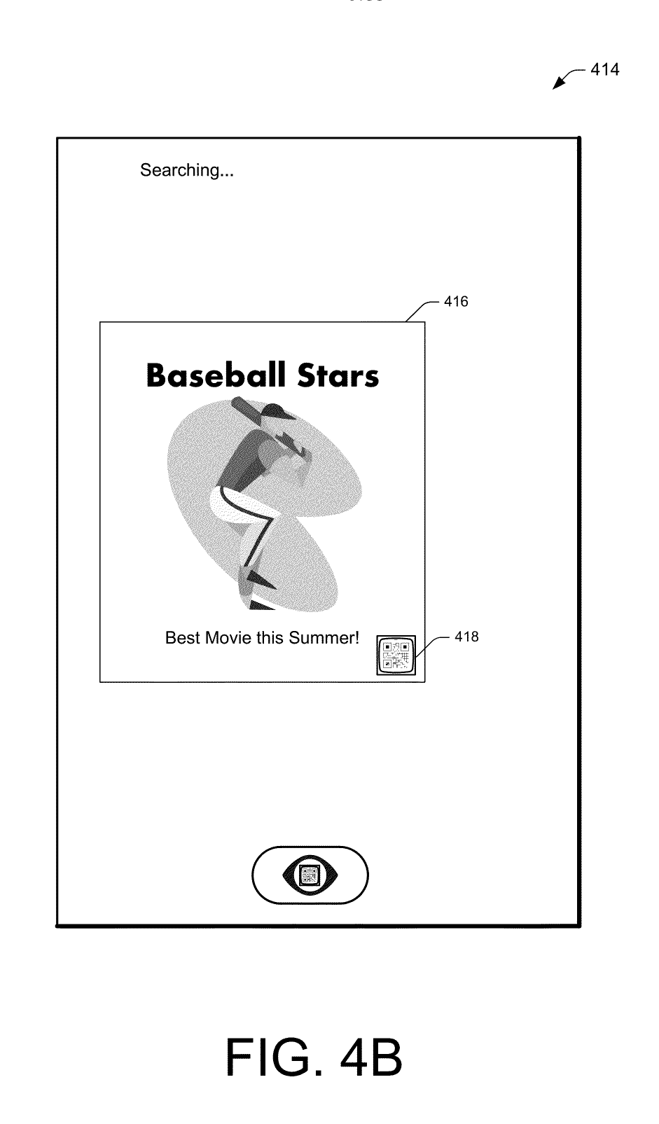

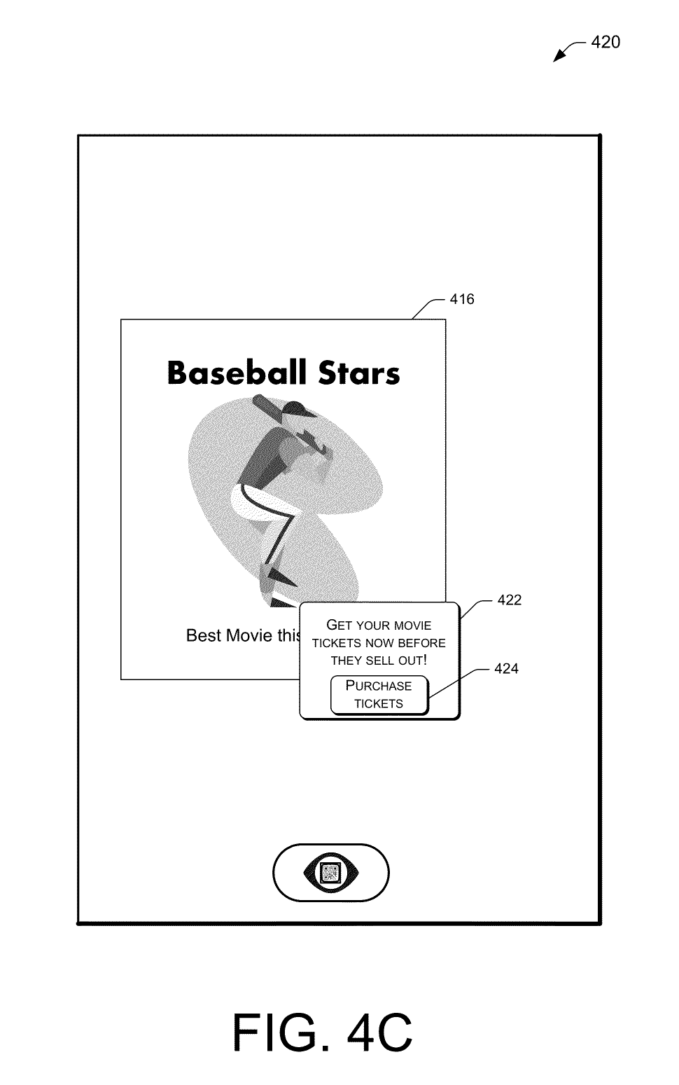

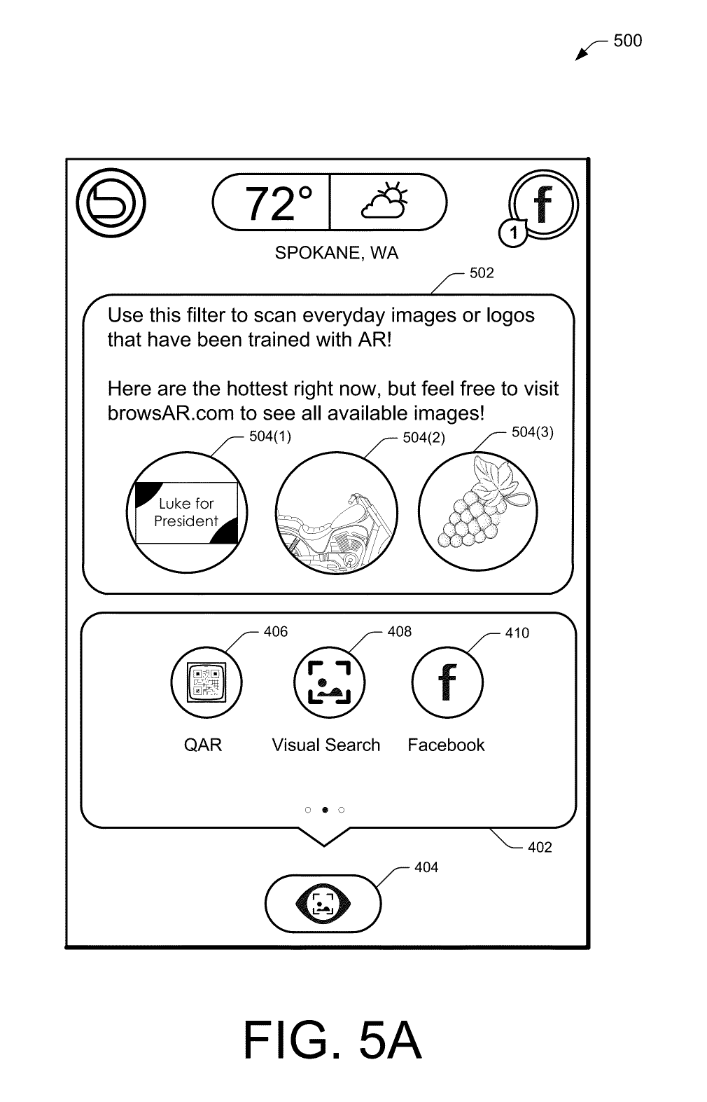

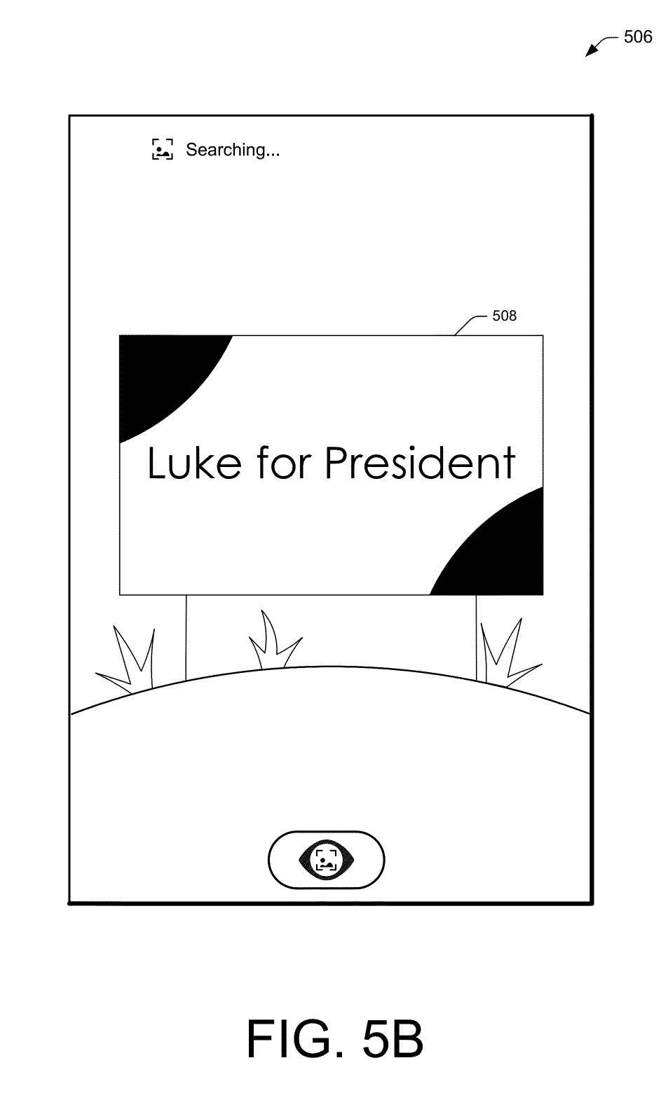

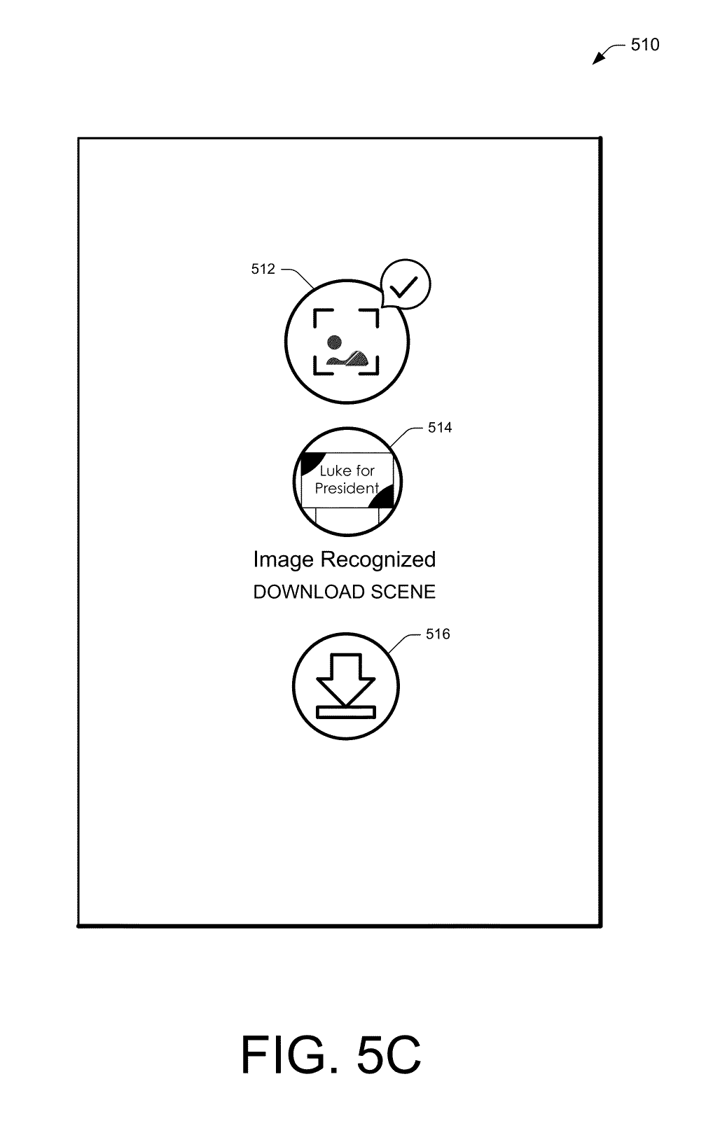

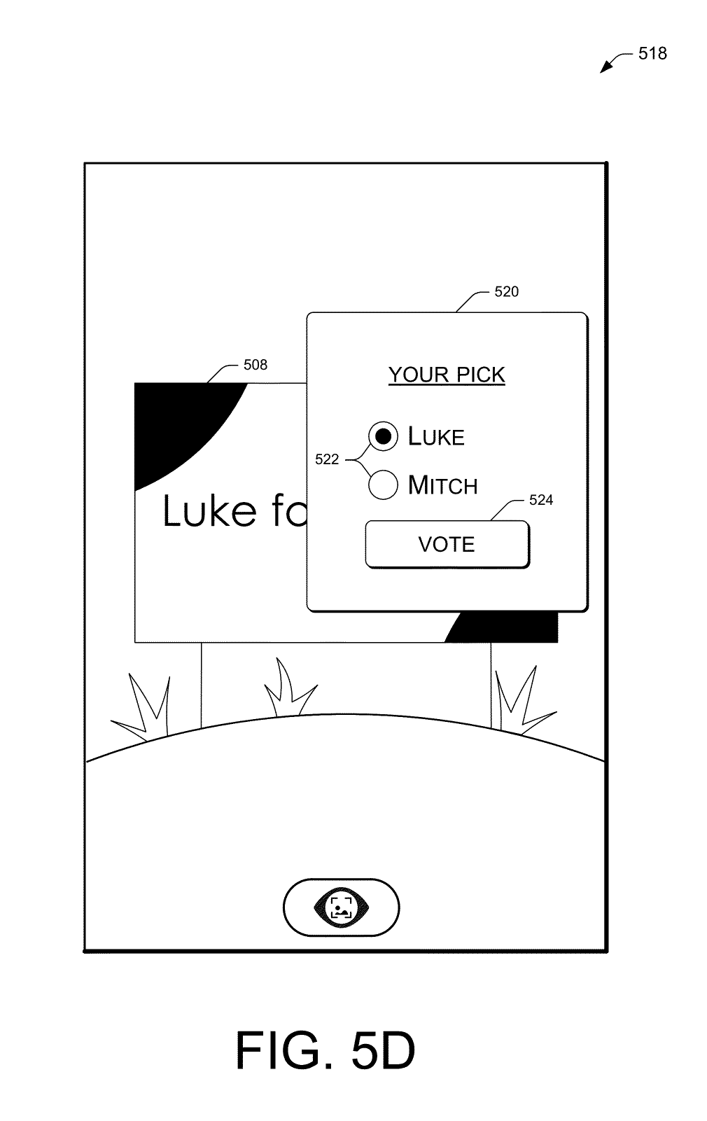

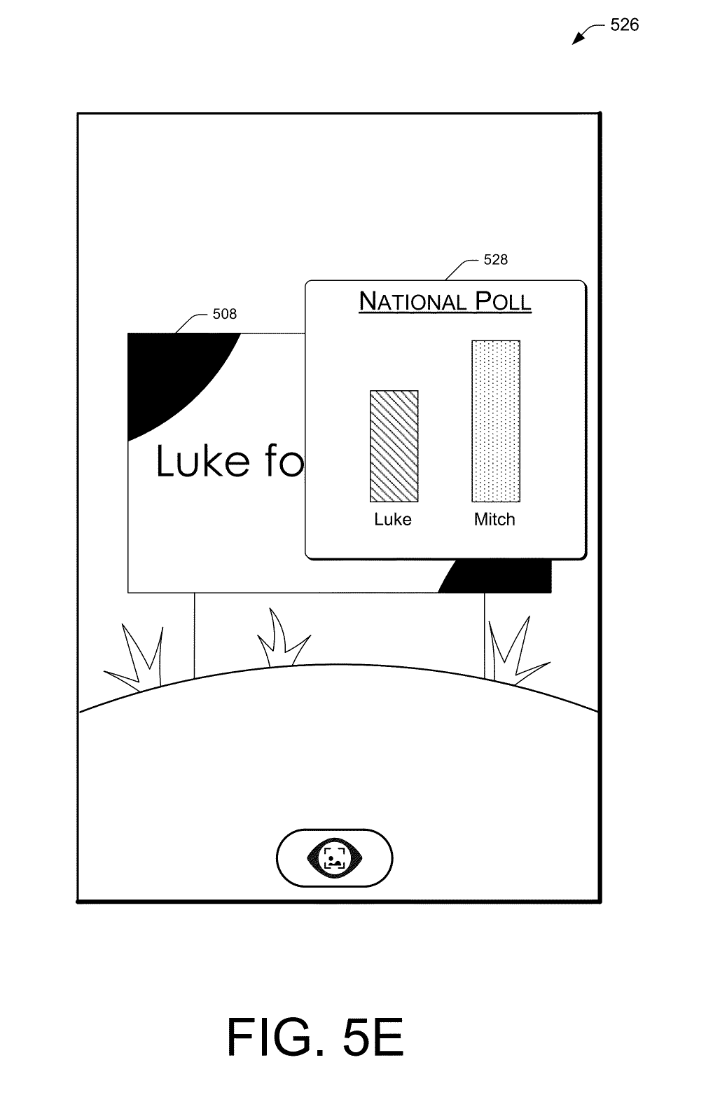

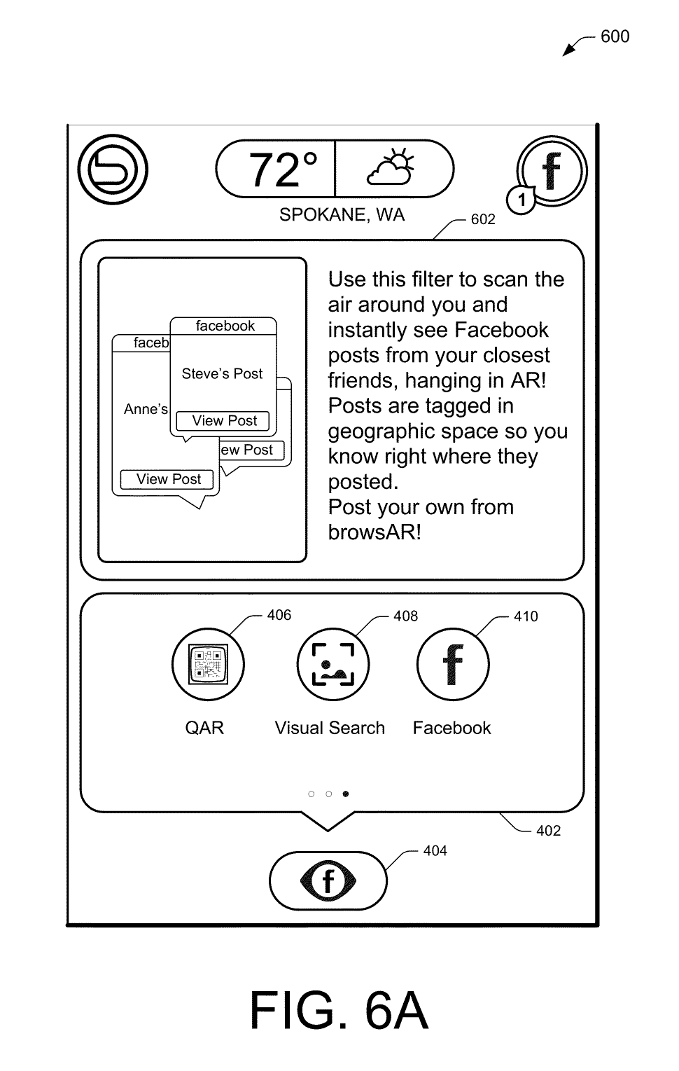

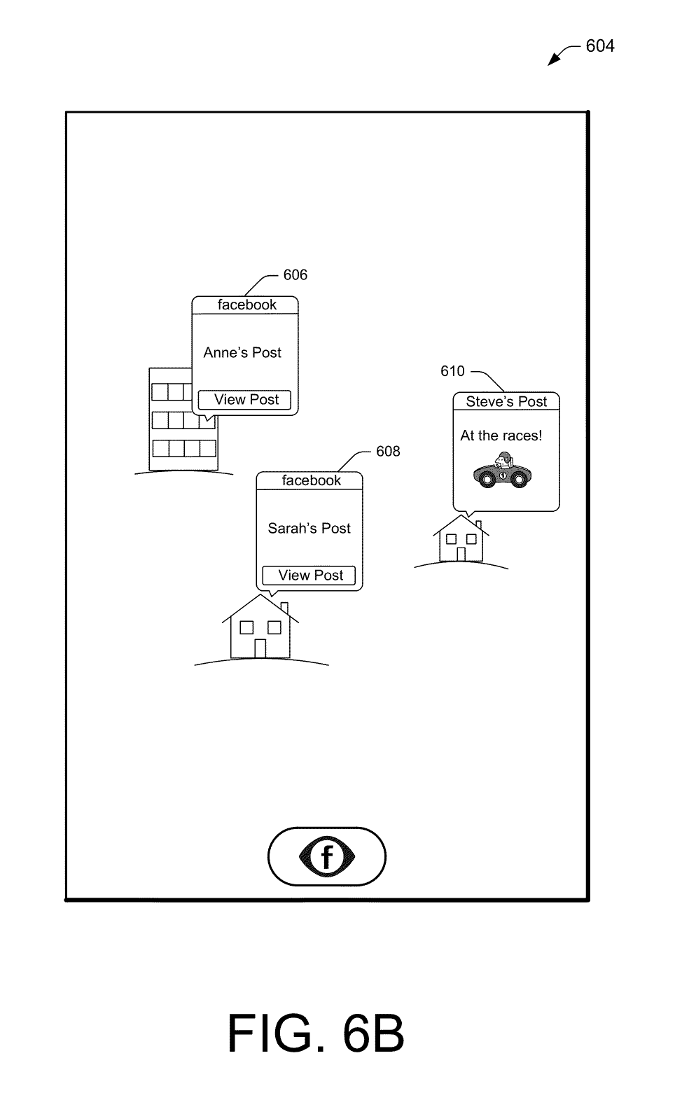

FIGS. 4-6 illustrate example interfaces that may be presented on the device 102 to provide an AR experience. These interfaces are associated with different types of search modes. In particular, FIGS. 4A-4C illustrate example interfaces that may be output on the device 102 in a QAR or QR (Quick Response code) search mode in which the device 102 scans an environment for fiduciary markers, such as surfaces containing QAR or QR codes. FIGS. 5A-5E illustrate example interfaces that may be output in a visual search mode in which the device 102 scans the environment for any type of textured target. Further, FIGS. 6A-6B illustrate example interfaces that may be output in a social media search mode in which the device 102 scans the environment for geographical locations that are associated with social media content.

FIG. 4A illustrates an interface 400 that may initially be presented on the device 102 in the QAR search mode. The top portion of the interface 400 may include details about the weather and information indicating a status of social media content. As illustrated, the interface 400 includes a window 402 that is presented upon selection of a search icon 404. The window 402 includes icons 406-410 to perform different types of searches. The QAR icon 406 enables a QAR search mode, the visual search icon 408 enables a visual search mode, and the social media icon 410 (labeled Facebook®) enables a social media search mode. Upon selection of the icon 406, a window 412 is presented in the interface 400. The window 412 may include details about using the QAR search mode, such as a tutorial.

FIG. 4B illustrates an interface 414 that may be presented on the device 102, upon selecting the search icon 404 in FIG. 4A a second time. In this example, the device 102 begins a scan of the environment and captures an image of a poster 416 for a recently released movie about baseball entitled “Baseball Stars.” The image is analyzed to find a QAR or QR code. As illustrated, the poster 416 includes a QAR or QR code 418 in the bottom right-hand corner.

FIG. 4C illustrates an interface 420 that may be presented on the device 102 upon identifying the QAR code 418 in FIG. 4B. Here, the interface 420 includes AR content, namely an advertisement window 422 for the movie poster 416. The window 422 includes a selectable button 424 to enable the user 110 to purchase a ticket for the movie. In this example, the window 422 (AR content) is displayed substantially centered over the QAR code 418. Although in other examples the window 422 is displayed in other locations in the interface 420, such as within a predetermined proximity to the QAR code 418. As the user 110 moves in the environment, the window 422 may be displayed in constant relation to the QAR code 418.

FIG. 5A illustrates an interface 500 that may initially be presented on the device 102 in the visual search mode. In this example, the user 110 has selected the search icon 404 and, thereafter, selected the visual search icon 408 causing a window 502 to be presented. The window 502 may include details about using the visual search mode, such as a tutorial and/or images 504(1)-(3). The images 504 may illustrate textured targets that are associated with AR content to thereby assist the user 110 in finding AR content for the environment. For example, the image 504(1) indicates that AR content is associated with a “Luke for President” poster.

FIG. 5B illustrates an interface 506 that may be presented on the device 102 upon selection of the search icon 404 in FIG. 5A while in the visual search mode. Here, the device 102 begins scanning the environment and processing images of textured targets (e.g., sending feature information to the AR service 104). In this example, an image of a “Luke for President” poster 508 is obtained and is being processed.

FIG. 5C illustrates an interface 510 that may be presented on the device 102 upon recognizing a textured target and determining that the textured target is associated with AR content. The interface 510 includes an icon 512 indicating that a textured target associated with AR content is recognized (e.g., image is recognized). That is, the icon 512 may indicate that a surface within the environment is identified as being associated with AR content. An icon 514 may also be presented to display an image of the recognized target, in this example the poster 508. The interface 510 may also include an icon 516 to enable the user 110 to download the associated AR content (e.g., through selection of the icon 516).

FIG. 5D illustrates an interface 518 that may be presented on the device 102 upon selection of the icon 516 in FIG. 5C. The interface 518 includes AR content, namely a window 520, displayed in an overlaid manner in relation to the poster 508 (e.g., overlaid over a portion of the poster 508). Here, the window 520 enables the user 110 to select one of radio controls 522 and submit the selection through a vote button 524.

FIG. 5E illustrates an interface 526 that may be presented on the device 102 upon selection of the vote button 524 in FIG. 5D. Here, a window 528 is presented including polling details about the presidential campaign, indicating that the other candidate Mitch is in the lead. By displaying the windows 520 and 528 while a substantially real-time image of the environment is displayed, the user's experience with the environment may be enhanced.

FIG. 6A illustrates an interface 600 that may initially be presented on the device 102 in the social media search mode. In this example, the user 110 has selected the search icon 404 and, thereafter, selected the social media search icon 410 causing a window 602 to be presented. The window 602 may include details about using the social media search mode, such as a tutorial. Although not illustrated, in instances where the social media search requires authentication to a social networking service (e.g., in order to view social media content), the user 110 may be required to authenticate to the social networking site before proceeding with the social media search mode. As such, in some instances the social media content may include content from users that are associated with the user 110 (e.g., “friends”).

FIG. 6B illustrates an interface 604 that may be presented on the device 102 upon selection of the search icon 404 in FIG. 6A while in the social media search mode. Here, the device 102 begins a social media search by determining a geographical location being imaged by the device 102 (e.g., a geographical location of one or more pixels of an image). The determination may be based on a reading from a sensor of the device 102 (e.g., an accelerometer, magnetometer, etc.) and/or image processing techniques performed on the image. The geographical location may then be sent to the AR service 104. The AR service 104 may determine whether social media content is associated with the location by, for example, communicating with one or more social networking services. Social media content may be associated with the location when, for example, content (e.g., textual, video, audio, etc.) is posted in association to the location, profile information of another user (e.g., a friend) indicates that the other user is associated with the location, or otherwise. When social media content is associated with the location, the social media content or social media information indicating that the social media content is associated with the geographical location may be sent to the device 102.

In the example of FIG. 6B, the interface 604 includes social media information 606 and 608 displayed at locations associated with the social media information (e.g., a building for information 606 and a house for information 608). Further, the interface 604 displays social media content 610 (e.g., a posted image of a car and text) at a location associated with the social media content 610. Here, the user 110 has already selected a “View Post” button for the content 610. By providing social media information and content, the user 110 may view social media content from “friends” or other individuals as the user 110 scans a neighborhood or other environment.

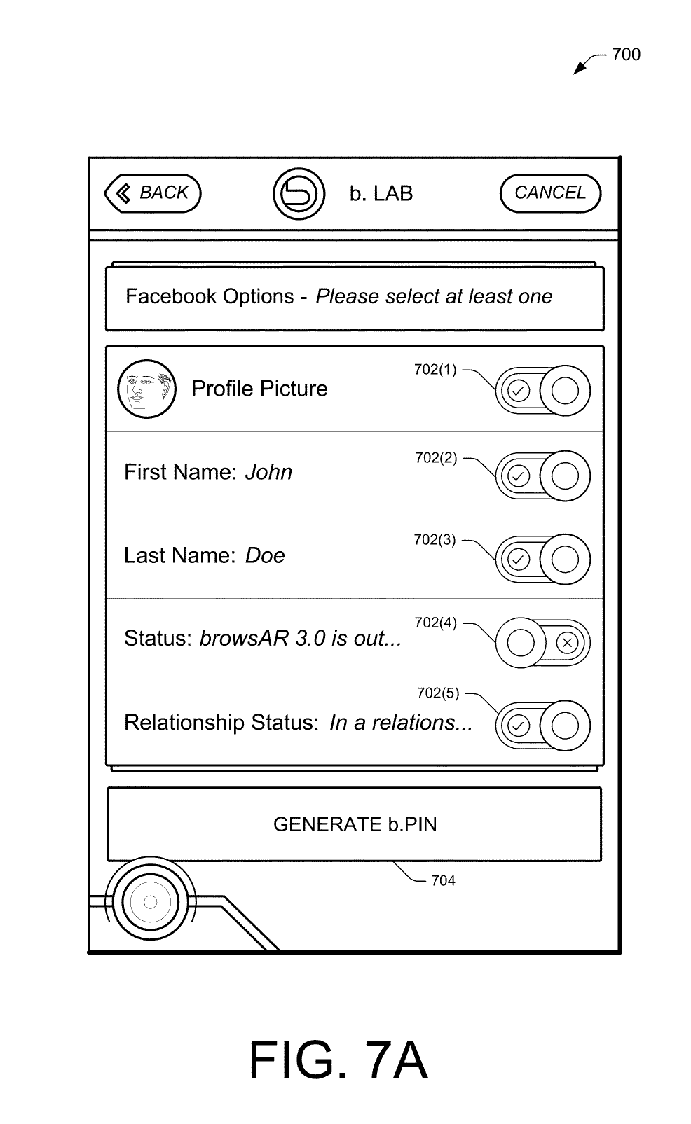

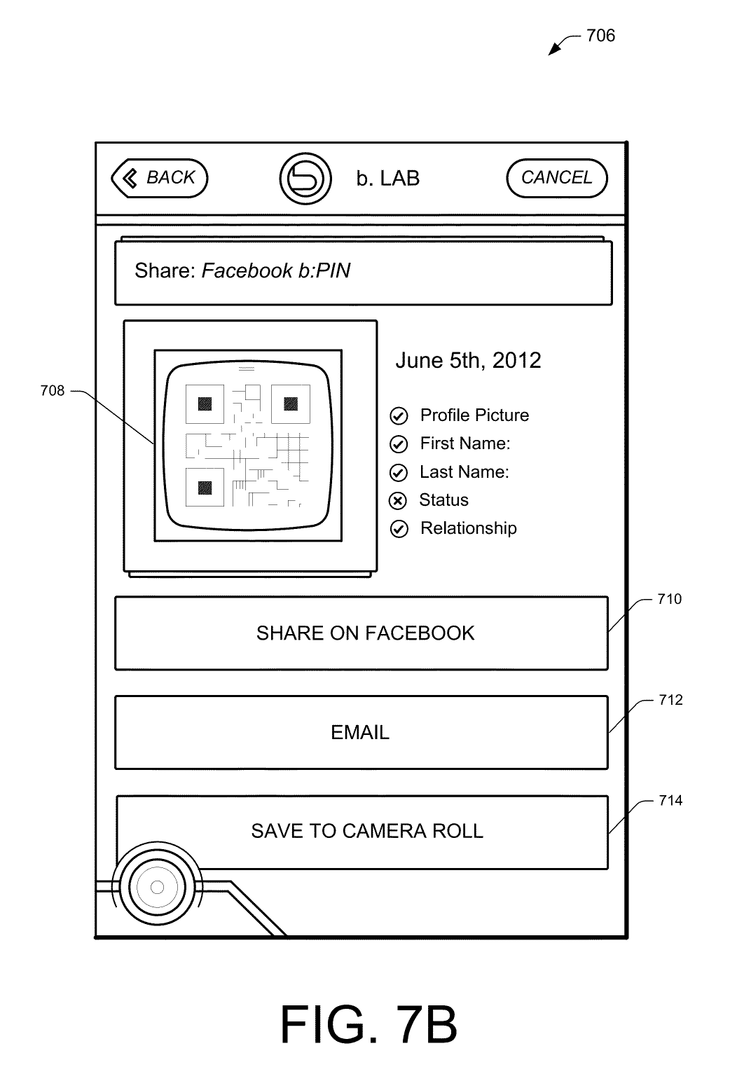

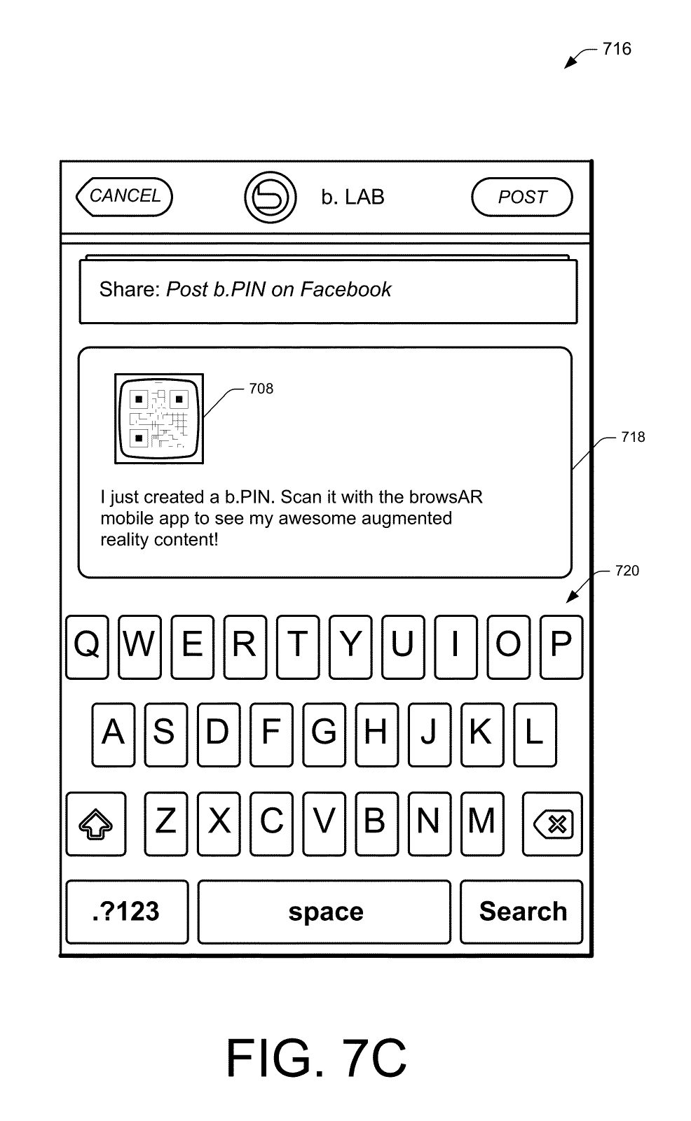

FIGS. 7A-7C illustrate example interfaces that may be presented on the device 102 to generate a personalized QAR or QR code. The personalized QAR code may include information that is specific to an individual, such as selected profile information. The personalized QAR code may be shared with other users through a social networking service, notification (e.g., email, text message, etc.), printed media (e.g., printed on a shirt, business card, letter, etc.), and so on.

In particular, FIG. 7A illustrates an example interface 700 that may be presented on the device 102 to select information to be included in a personalized QAR code. As illustrated, the interface 700 includes interface elements 702(1)-(5) that are selectable to enable the user 110 select what types of information will be included. For example, the user 110 may decide to include a picture, name, status, relationship, or other information in the personalized QAR code. Selection of a button 704 may then cause the personalized QAR (e.g., b.PIN) to be generated. In some instances, the QAR code is generated at the device 102, while in other instances the QAR code is generated at the AR service 104 and sent to the device 102 and/or another device.

FIG. 7B illustrates an interface 706 that may be presented on the device 102 upon selection of the button 704 in FIG. 7A. The interface 706 may enable the user 110 to view, store, and/or share a personalized QAR code 708. In some instances, the interface 706 may allow the user 110 to verify the information that is included in the QAR code 708 before sharing the code 708 with others. The interface 706 may include a button 710 to send the code 708 to another user through a social networking service (e.g., Facebook®), a button 712 to send the code 708 through a notification (e.g., email), and a button 714 to store the code 708 locally at the device 102 or remotely to the device 102 (e.g., at the AR service 104). When the code 708 is shared through a social networking service, the code 708 may be posted or otherwise made available to other users.

FIG. 7C illustrates an interface 716 that may be presented on the device 102 to send (e.g., share) the QAR code 708 through a social networking service. The interface 716 includes a window 718 to enable a message to be created and attached to the code 708. The message may be created through use of a keyboard 720 displayed through the interface 716. Although the interface of FIG. 7C is described as being utilized to share the code 708 within a social networking service, it should be appreciated that many of the techniques and interface elements may similarly be used to share the code 708 through another means.

### Example Processes

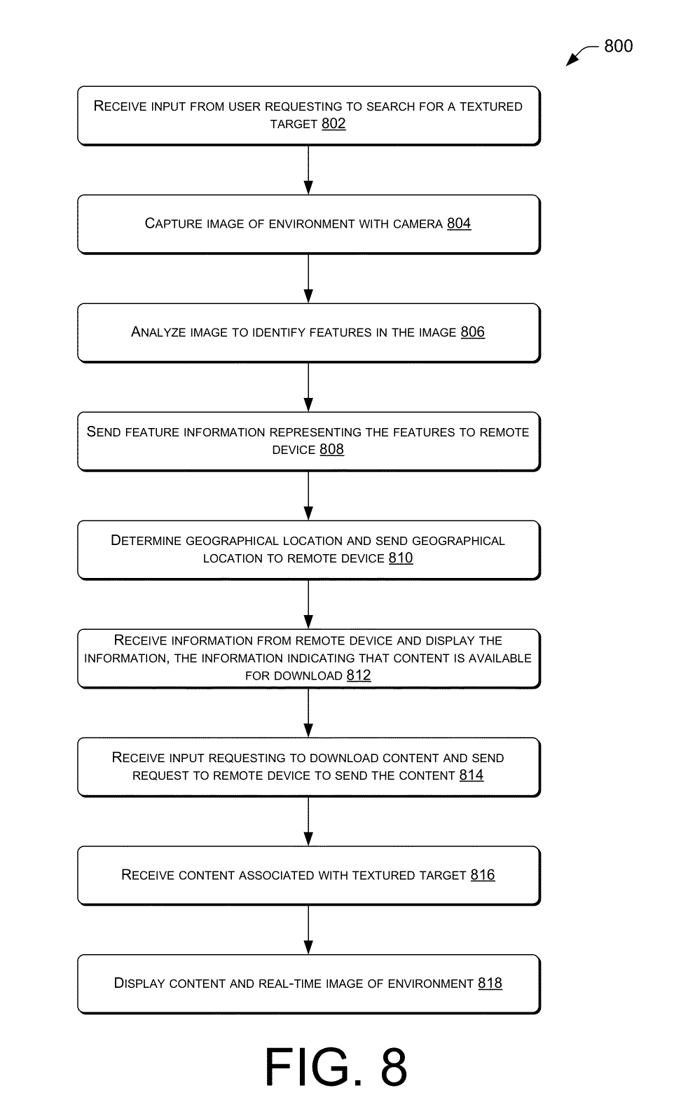

FIGS. 8-10 illustrate example processes 800, 900, and 1000 for employing the techniques described herein. For ease of illustration processes 800, 900, and 1000 are described as being performed in the architecture 100 of FIG. 1. For example, one or more operations of the process 800 may be performed by the device 102 and one or more operations of the processes 900 and 1000 may be performed by the AR service 104. However, processes 800, 900, and 1000 may be performed in other architectures, and the architecture 100 may be used to perform other processes.

The processes 800, 900, and 1000 (as well as each process described herein) are illustrated as a logical flow graph, each operation of which represents a sequence of operations that can be implemented in hardware, software, or a combination thereof In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the process.

FIG. 8 illustrates the process 800 for searching within an environment for a textured target that is associated with AR content and outputting AR content when such a textured target is recognized.

At 802, the device 102 may receive input from the user 110 through, for example, an interface. The input may request to search for a textured target (e.g., a surface or portion of a surface) within the environment that is associated with AR content.

At 804, the device 102 may capture one or more images of the environment with a camera of the device 102. In some instances, information may be displayed in an interface to indicate that the searching has begun.

At 806, the device 102 may analyze the one or more images to identify features in the one or more images. That is, features associated with a particular textured target may be identified. At 806, the device 102 may also extract/generate feature information, such as feature descriptors, representing the features. At 808, the device 102 may send the feature information to the AR service 104 so that the service 104 may identify the textured target described by the feature information.

In some instances, at 810 the device 102 may determine a geographical location of the device 102 or a textured target within an image and send the geographical location to the AR service 104. This information may be used to modify AR content sent to the device 102.

At 812, the device 102 may receive information from the AR service 104 and display the information through, for example, an interface. The information may indicate that the AR service has identified a textured target, that AR content is associated with the textured target, and/or that the AR content is available for download.

At 814, the device 102 may receive input from the user 110 through, for example, an interface requesting to download the AR content. The device 102 may send a request to the AR service 104 and/or the content source 106 to send the AR content. At 816, the device 102 may receive the AR content from the AR service 104 and/or the content source 106.

At 818, the device 102 may display the AR content along with a real-time image of the environment of the device 102. The AR content may be displayed in an overlaid manner on the real-time image at a location on the display that has some relation to a displayed location of the textured target. For example, the AR content may be displayed on top of the textured target or within a predetermined proximity to the target. Thereafter, as the real-time image of the environment changes (e.g., due to movement of the device 102), an orientation, scale, and/or displayed location of the AR content may be modified to maintain the relation between the textured target and the AR content.

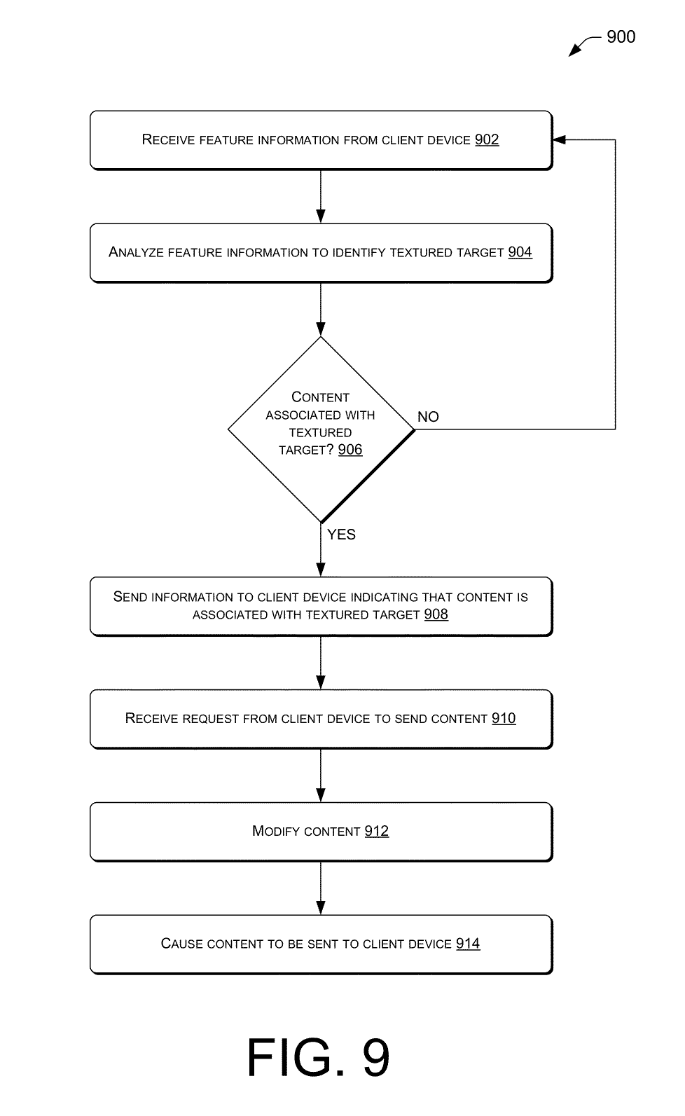

FIG. 9 illustrates the process 900 for analyzing feature information to identify a textured target and providing AR content that is associated with the textured target. As noted above, the process 900 may be performed by the AR service 104.

At 902, the AR service 104 may receive feature information from the device 104. The feature information may represent features of an image captured from an environment in which the device 102 resides.

At 904, the AR service 104 may analyze the feature information to identify a textured target associated with the feature information. The analysis may comprise comparing the feature information with other feature information for a plurality of textured targets.

At 906, the AR service 104 may determine whether AR content is associated with the textured target identified at 904. When there is no AR content associated with the textured target, the process 900 may return to 902 and wait to receive further feature information. Alternatively, when AR content is associated with the textured target, the process may proceed to 908.

At 908, the AR service 104 may send information to the device 102 indicating that AR content is associated with a textured target in the environment of the device 102. The information may also indicate an identity of the textured target. At 910, the AR service 104 may receive a request from the device 102 to send the AR content.

In some instances, at 912 the AR service 104 may modify the AR content. The AR content may be modified based on a geographical location of the device 102, profile information of the user 110, or other information. This may create personalized content.

At 914, the AR service 104 may cause the AR content to be sent to the device 102. When, for example, the AR content is stored at the AR service 104, the content may be sent from the service 104. When, however, the AR content is stored at a remote site, such as the content source 106, the AR service 104 may instruct the content source 106 to send the AR content to the device 102 or to send the AR content to the AR service 104 to relay the content to the device 102.

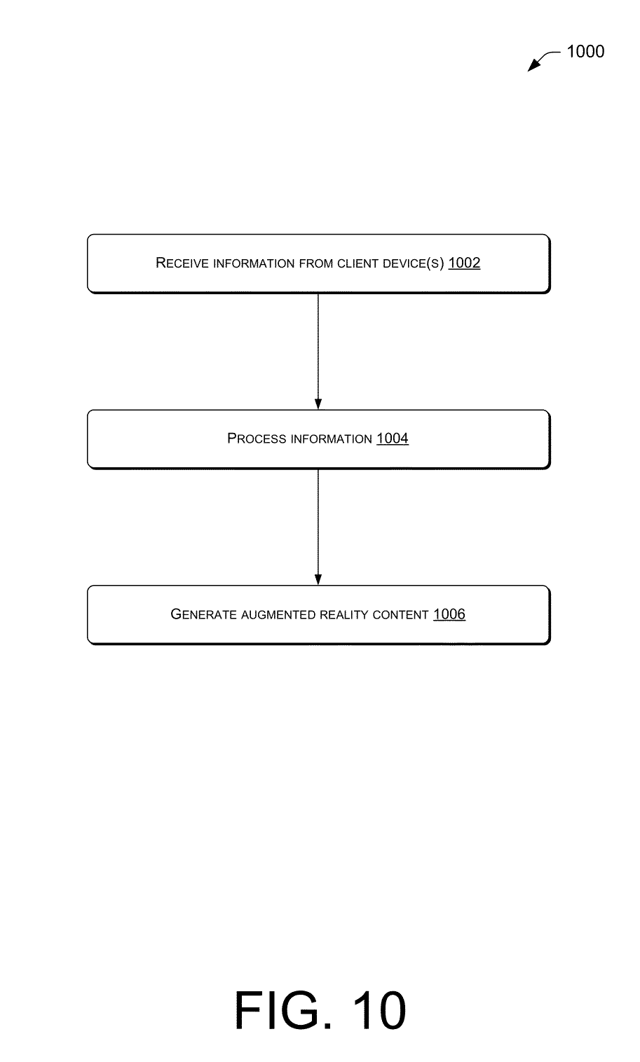

FIG. 10 illustrates the process 1000 for generating AR content. As noted above, the process 1000 may be performed by the AR service 104.

At 1002, the AR service 104 may receive information from one or more devices. The information may relate to opinions or other input from users associated with the one or more devices, such as polling information.

At 1004, the AR service 104 may process the information to obtain more useful information, such as metrics, trends, and so on. For example, the AR service 104 may determine that a relatively large percentage of people in the Northwest will be voting for a particular presidential candidate over another candidate.

At 1006, the AR service 104 may generate AR content from the processed information. For example, the AR content may include graphs, charts, interactive content, statistics, trends, and so on, that are associated with the input from the users. The AR content may be stored at the AR service 104 and/or at the content source 106.

### Conclusion

Although embodiments have been described in language specific to structural features and/or methodological acts, it is to be understood that the disclosure is not necessarily limited to the specific features or acts described. Rather, the specific features and acts are disclosed herein as illustrative forms of implementing the embodiments.

What is claimed is:

1. A portable computing device comprising:
a display;
a camera;
one or more processors; and
memory, communicatively coupled to the one or more processors, storing executable instructions that, when executed by the one or more processors, perform acts comprising:
capturing an image with the camera, the image representing a textured target in an environment in which the portable computing device is located;
identifying features in the image that correspond to points of interest;
sending feature information representing the features to a remote computing device to identify the textured target and obtain content associated with the textured target;
receiving the content that is associated with the textured target from the remote computing device; and
simultaneously displaying the content and a substantially real-time image of the environment on the display.

2. The portable computing device of claim 1, wherein displaying the content includes displaying the content over the real-time image at a location that is related to a displayed location of the textured target.

3. The portable computing device of claim 2, wherein the content is displayed at the displayed location of the textured target or within a predetermined proximity to the displayed location of the textured target.

4. The portable computing device of claim 1, wherein the textured target comprises a surface or a portion of a surface within the environment that has a particular textured characteristic.

5. The portable computing device of claim 1, wherein the feature information comprises one or more feature descriptors describing the features.

6. The portable computing device of claim 1, wherein the content comprises item details for an item related to the textured target, interactive content that is selectable by a user, or social media content associated with the textured target.

7. A computer-implemented method comprising:
under control of a client computing device configured with computer-executable instructions,
obtaining an image through a camera of the client computing device, the image at least partly representing an environment in which the client computing device is located;
identifying features in the image that correspond to points of interest;
identifying a textured target associated with the features; and
displaying content that is associated with the textured target on a display of the client computing device while displaying the image or another image of the environment on the display.

8. The method of claim 7, wherein displaying the content comprises displaying the content over the image or the other image at a location that is related to a displayed location of the textured target.

9. The method of claim 8, wherein the content is displayed at the displayed location of the textured target or within a predetermined proximity to the displayed location of the textured target.

10. The method of claim 7, wherein the content comprises item details for an item related to the textured target, interactive content that is selectable by a user, or social media content associated with the textured target.

11. The method of claim 7, wherein the client computing device comprises a smart phone or a tablet computer.

12. The method of claim 7, further comprising:
before displaying the content, determining a geographical location of the client computing device, the content that is displayed on the display of the client computing device being based at least in part on the geographical location of the client computing device.

13. A method comprising:
receiving input from a user through an interface, the input requesting to search for a textured target that is associated with content;
searching in an environment of the user to identify the textured target that is associated with content;
upon identifying the textured target within the environment, displaying information in the interface indicating that the content is available for download;
receiving through the interface input from the user requesting to download the content; and
upon receiving the input requesting to download the content, downloading the content and displaying the content in the interface while a substantially real-time image of the environment is displayed in the interface.

14. The method of claim 13, wherein searching in the environment to identify the textured target comprises:
obtaining an image that at least partly includes the textured target;
identifying features in the image that correspond to points of interest;
sending feature information representing the features to a remote computing device; and
receiving information from the remote computing device indicating that the textured target is identified.

15. The method of claim 13, wherein upon initializing searching for the textured target, displaying information in the interface indicating that the search is being performed.

16. The method of claim 13, wherein the content comprises item details for an item related to the textured target, interactive content that is selectable by a user, or social media content associated with the textured target.

17. One or more computer-readable storage media storing computer-readable instructions that, when executed, instruct one or more processors to perform operations comprising:
receiving input from a user through an interface, the input requesting to identify social media content within an environment of the user;
searching in the environment of the user to identify social media content that is associated with a geographical location being imaged;
upon identifying the social media content, displaying social media information in the interface at a location in a substantially real-time image of the environment, the location corresponding to the geographical location of the social media content.

18. The one or more computer-readable storage media of claim 17, wherein the social media information indicates that a post from a user of a social network has been associated with the geographical location.

19. The one or more computer-readable storage media of claim 17, wherein the social media information indicates an identity of a user of a social network that is associated with the geographical location.

20. The one or more computer-readable storage media of claim 17, wherein the operations further comprise:
upon displaying the social media information, receiving a selection of the social media information from the user through the interface; and
upon receiving the selection of the social media information, displaying the social media content.

21. The one or more computer-readable storage media of claim 20, wherein the social media content comprises a post from another user or profile information of the other user.

22. The one or more computer-readable storage media of claim 17, wherein searching in the environment to identify the social media content comprises:
obtaining an image of the environment of the user;
determining a geographical location associated with one or more pixels in the image;
sending the geographical location associated with the one or more pixels to a remote computing device; and
receiving the social media information from the remote computing device or another remote computing device, the social media information being associated with the geographical location of the one or more pixels.

23. A computer-implemented method comprising:
under control of a client computing device configured with computer-executable instructions,
obtaining an image through a camera of the client computing device, the image at least partly representing an environment in which the client computing device is located;
identifying features in the image that correspond to points of interest;
identifying a textured target associated with the features;
determining a geographical location associated with the image or the client computing device; and
simultaneously displaying content and a substantially real-time image of the environment, the content being based at least in part on the identified textured target and the geographical location.
